(19) United States
(12) Patent Application Publication
(10) Pub. No.: US 2023/0111393 A1
(43) Pub. Date: Apr. 13, 2023

(54) INFORMATION PROCESSING APPARATUS AND METHOD, AND NON-TRANSITORY COMPUTER-READABLE STORAGE MEDIUM

(71) Applicant: CANON KABUSHIKI KAISHA, Tokyo (JP)

(72) Inventor: Akane Iseki, Kanagawa (JP)

(21) Appl. No.: 17/955,648

(22) Filed: Sep. 29, 2022

(30) Foreign Application Priority Data
Oct. 7, 2021 (JP) 2021-165650

(51) Int. Cl. G06T 7/246; G06T 7/73; G06T 7/60

(52) U.S. Cl. CPC G06T 7/248; G06T 7/74; G06T 7/60; G06T 2207/20084; G06T 2207/20081

(57) ABSTRACT

An estimation unit, based on the features of the respective positions in the image extracted by the extraction unit, estimates a position where the tracking target exists within an image. A first error calculation unit calculates a first error between a position of the tracking target within the search image that has been estimated by the estimation unit and the position of the tracking target within the search image that is indicated by the ground truth data. A feature obtaining unit obtains first features, second features, and third features. A second error calculation unit calculates, as a second error, a relative magnitude of a distance between the first features and the second features relative to a distance between the first features or the second features and the third features in a feature space.

### BACKGROUND OF THE INVENTION

### Field of the Invention

The present invention relates to an information processing apparatus and method, and a non-transitory computer-readable storage medium.

### Description of the Related Art

In recent years, attention has been drawn to a technique that utilizes meta-learning of a deep neural network (hereinafter referred to as a DNN) in order to track a specific subject within an image with high accuracy. Meta-learning is a learning method for obtaining a model that can adapt to a new task with a small amount of data and updating of parameters. By applying meta-learning to a tracking task, a DNN that tracks a subject with high accuracy is realized.

In meta-learning of a tracking task, parameters of an object detection DNN are adapted to a tracking target detection task with use of features that are extracted by a DNN from a reference image that shows a tracking target. For example, a Siam method calculates correlations between the features that are extracted by a DNN from both of a reference image and a search range image. For example, see High Performance Visual Tracking with Siamese Region Proposal Network, Li et al., CVPR 2018. An online tracking method performs fine tuning of parameters of an object detection DNN based on a gradient method with use of a reference image. For example, see Learning Discriminative Model Prediction for Tracking, Bhat et al., ICCV 2019, and Tracking by Instance Detection: A Meta-Learning Approach, Wang et al., CVPR 2020. In this way, information of a tracking target is imported to an object detection DNN, and the object detection DNN can detect the tracking target from a new image.

The result of detecting a tracking target from a new image is evaluated using an object detection DNN that has been adapted to detection of a tracking target; as a result, a feature extraction DNN and an object detection DNN perform learning. In this way, a DNN that maximizes the performance of detection of a tracking target from a new image can be achieved simply by executing parameter adaptation with respect to an object detection DNN with use of a reference image.

### SUMMARY OF THE INVENTION

The present invention in its one aspect provides an information processing apparatus comprising an obtaining unit configured to obtain a reference image and a search image that show a tracking target, and ground truth data indicating a position of the tracking target within the search image, an extraction unit configured to extract features of respective positions in an image, an estimation unit configured to, based on the features of the respective positions in the image extracted by the extraction unit, estimate a position where the tracking target exists within an image, a first error calculation unit configured to calculate a first error between a position of the tracking target within the search image that has been estimated by the estimation unit and the position of the tracking target within the search image that is indicated by the ground truth data, a feature obtaining unit configured to obtain first features, second features, and third features, the first features being features of the tracking target that have been extracted by the extraction unit from the reference image, the second features being features of the tracking target at the position indicated by the ground truth data that have been extracted by the extraction unit from the search image, the third features being features of a similar object similar to the tracking target that have been extracted by the extraction unit at least from the search image, a second error calculation unit configured to calculate, as a second error, a relative magnitude of a distance between the first features and the second features relative to a distance between the first features or the second features and the third features in a feature space, and an updating unit configured to update a parameter used by the extraction unit in extraction of the features based on the first error and the second error.

The present invention in its one aspect provides an information processing apparatus comprising an obtaining unit configured to obtain a search image and ground truth data indicating a position of a tracking target within the search image, an extraction unit configured to extract features of respective positions in an image, an estimation unit configured to, based on features of respective positions in the search image extracted by the extraction unit, estimated a likelihood of existence of the tracking target with respect to each position within the search image, a feature obtaining unit configured to obtain first features and third features, the first features being features of the tracking target that have been extracted by the extraction unit from the search image, the third features being features of a similar object similar to the tracking target which have been extracted by the extraction unit from the search image and which are at a position of the similar object estimated based on the likelihood and on the ground truth data indicating the position of the tracking target within the search image, and an updating unit configured to update a parameter used by the extraction unit in extraction of the features based on a distance between the first features and the third features in a feature space.

The present invention in its one aspect provides a method comprising obtaining a reference image and a search image that show a tracking target, and ground truth data indicating a position of the tracking target within the search image, extracting features of respective positions in an image, estimating, based on the features of the respective positions in the image extracted, a position where the tracking target exists within an image, calculating a first error between a position of the tracking target within the search image that has been estimated and the position of the tracking target within the search image that is indicated by the ground truth data, obtaining first features, second features, and third features, the first features being features of the tracking target that have been extracted from the reference image, the second features being features of the tracking target at the position indicated by the ground truth data that have been extracted from the search image, the third features being features of a similar object similar to the tracking target that have been extracted at least from the search image, calculating, as a second error, a relative magnitude of a distance between the first features and the second features relative to a distance between the first features or the second features and the third features in a feature space, and updating a parameter used in extraction of the features based on the first error and the second error.

The present invention in its one aspect provides a non-transitory computer-readable storage medium storing a program that, when executed by a computer, causes the computer to perform a method comprising obtaining a reference image and a search image that show a tracking target, and ground truth data indicating a position of the tracking target within the search image, extracting features of respective positions in an image, estimating, based on the features of the respective positions in the image extracted, a position where the tracking target exists within an image, calculating a first error between a position of the tracking target within the search image that has been estimated and the position of the tracking target within the search image that is indicated by the ground truth data, obtaining first features, second features, and third features, the first features being features of the tracking target that have been extracted from the reference image, the second features being features of the tracking target at the position indicated by the ground truth data that have been extracted from the search image, the third features being features of a similar object similar to the tracking target that have been extracted at least from the search image, calculating, as a second error, a relative magnitude of a distance between the first features and the second features relative to a distance between the first features or the second features and the third features in a feature space, and updating a parameter used in extraction of the features based on the first error and the second error.

Further features of the present invention will become apparent from the following description of exemplary embodiments (with reference to the attached drawings).

### BRIEF DESCRIPTION OF THE DRAWINGS

FIG. 1 is a diagram showing a configuration of an information processing apparatus.

FIG. 2 is a block diagram showing a functional configuration of the information processing apparatus.

FIG. 3 is a diagram showing the configurations of neural networks.

FIG. 4A is a diagram showing a reference image.

FIG. 4B is a diagram showing a search image.

FIG. 5A is a diagram showing one example of various types of images and the like that are supplied to the neural networks.

FIG. 5B is a diagram showing one example of various types of images and the like that are supplied to the neural networks.

FIG. 5C is a diagram showing one example of various types of images and the like that are supplied to the neural networks.

FIG. 5D is a diagram showing one example of various types of images and the like that are supplied to the neural networks.

FIG. 5E is a diagram showing one example of various types of images and the like that are supplied to or outputted from the neural networks.

FIG. 6 is a flowchart of learning processing of the neural networks according to a first embodiment.

FIG. 7 is a diagram showing examples of configurations of neural networks used with an online tracking method.

FIG. 8 is a flowchart showing a flow of prior learning of NNs according to a fifth embodiment.

FIG. 9 is a flowchart of parameter updating processing in an online tracking method.

FIG. 10 is a flowchart of inference processing in an online tracking method.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

According to the present invention, the accuracy of detection of a tracking target can be improved.

### First Embodiment

In a first embodiment, cross-correlations between the features of tracking targets that are extracted respectively from a reference image and a search image are obtained, and an estimated error of the position of the tracking target within the search image (a first error) is derived. Also, in the first embodiment, a relative magnitude of the distance between features of tracking targets, which have been extracted using feature extraction NNs, relative to the distance between respective features of a tracking target and a similar object (a second error) is derived. In the first embodiment, parameters of the feature extraction NNs are updated simultaneously based on the first error and the second error, and the features of a tracking target within a search image are differentiated. Accordingly, in the first embodiment, the degree of similarity between features of a tracking target and a similar object can be lowered, and the accuracy of detection of a tracking target within a search image can be improved. Note that although a tracking target and a similar object are humans, no limitation is intended by this, and they may be, for example, animals, vehicles, and the like.

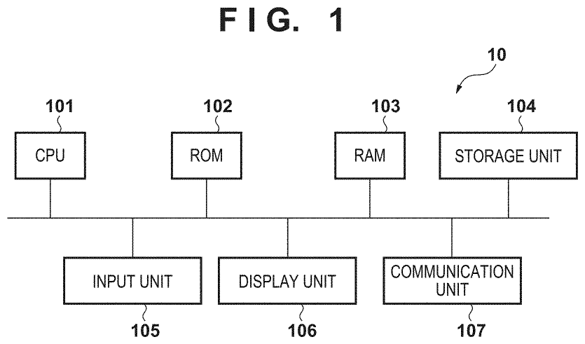

FIG. 1 is a diagram showing a configuration of an information processing apparatus. An information processing apparatus 10 includes a CPU 101, a ROM 102, a RAM 103, a storage unit 104, an input unit 105, a display unit 106, and a communication unit 107. The information processing apparatus 10 is an apparatus that learns a neural network, and includes, for example, a personal computer or the like.

The CPU 101 is an apparatus that controls each component of the information processing apparatus 10, and performs various types of processing by executing a program and data stored in the ROM 102 and the RAM 103.

The ROM 102 is a storage apparatus that stores various types of data, an activation program, and the like.

The RAM 103 temporarily stores various types of data of each component of the information processing apparatus 10. The RAM 103 includes a working area that is used when the CPU 101 executes various types of processing.

The storage unit 104 is a storage medium that holds data to be processed and data for learning, and includes, for example, an HDD, a flash memory, various types of optical mediums, and the like.

The input unit 105 is accepting means for accepting various types of instructional inputs from a user, and includes, for example, a mouse, a joystick, and various types of UIs.

The display unit 106 is an apparatus that displays various types of information on a screen, and includes, for example, a liquid crystal (LCD) screen, an organic EL screen, and a touchscreen. The display unit 106 displays a captured image captured by an image capturing apparatus (not shown), various types of screens, data received from a server (not shown), and the like. In a case where the display unit 106 is a touchscreen, the user inputs various types of instructions to the CPU 101 by touching the screen of the display unit 106.

The communication unit 107 is an apparatus that controls data communication with a server (not shown) connected to a network (not shown). The communication unit 107 includes, for example, a wired LAN, a wireless LAN, and the like for performing data communication with various types of terminal apparatuses.

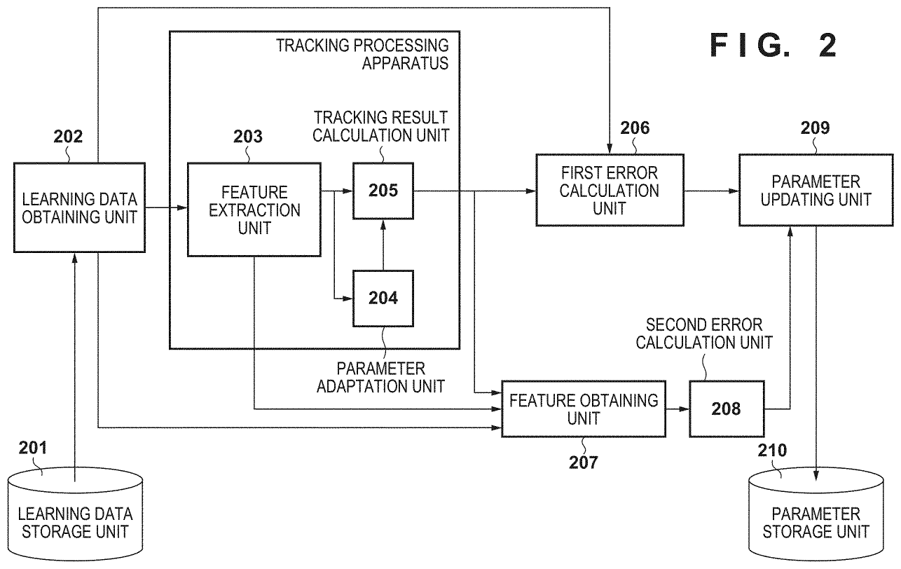

FIG. 2 is a block diagram showing a functional configuration of the information processing apparatus. The information processing apparatus 10 includes a learning data storage unit 201, a learning data obtaining unit 202, a feature extraction unit 203, a parameter adaptation unit 204, and a tracking result calculation unit 205. The information processing apparatus 10 further includes a first error calculation unit 206, a feature obtaining unit 207, a second error calculation unit 208, a parameter updating unit 209, and a parameter storage unit 210.

The learning data storage unit 201 stores later-described ground truth data that indicates the position and the size of a tracking target within a search image 304, the search image 304, and reference image 301. Hereinafter, ground truth data is also referred to as GT (Ground Truth).

The learning data obtaining unit 202 obtains the search image 304 inside the learning data storage unit 201, the ground truth data of the search image 304, and reference image 301.

The feature extraction unit 203 inputs the search image 304 to a later-described feature extraction NN 305 that extracts features of a tracking target from a search image, thereby extracting one feature map 306 per search image. The feature extraction unit 203 includes a feature extraction NN 302 and a feature extraction NN 305, which will be described later, and they have the same NN.

The parameter adaptation unit 204 updates parameters of a correlation calculation layer 307 inside a later-described tracking target detection NN 310. Specifically, the parameter adaptation unit 204 generates first features by cutting out a surrounding area of a tracking target within template features 303 that have been extracted by the feature extraction NN 302 of the feature extraction unit 203 from a reference image. The parameter adaptation unit 204 sets the first features as a parameter of the correlation calculation layer 307.

The tracking result calculation unit 205 calculates, in the correlation calculation layer 307, correlations between parameters thereof and the feature map 306 that has been extracted by the feature extraction unit 203 from the search image 304. Here, the parameter of the correlation calculation layer 307 refers to the features that have been obtained by the parameter adaptation unit 204 cutting out the features from the template features 303. The feature map 306 extracted from the search image 304 refers to the output from the final layer of the feature extraction NN 305. The tracking result calculation unit 205 inputs a correlation map 308 obtained from the correlation calculation layer 307 to an NN 309 inside the later-described tracking target detection NN 310. The tracking result calculation unit 205 estimates the position and the size of the tracking target with use of a likelihood map 311 that exhibits a strong reaction to the position of the tracking target and size estimation maps (a width map 312 and a height map 313), which are output from the NN 309. The tracking result calculation unit 205 includes the later-described tracking target detection NN 310. Also, the types of maps estimated by the NN 309 are not limited to these; for example, it is permissible to determine candidates for the size of the tracking target in advance, and estimate the amount by which the size is finely adjusted as a map, as in Non-Patent Literature 1.

The first error calculation unit 206 calculates a first error based on the estimated results of the position and the size of the tracking target that were estimated by the tracking result calculation unit 205 from the search image 304, and on GT of the tracking target within the search image 304.

The feature obtaining unit 207 obtains, from the feature map 306 obtained from the final laver of the feature extraction NN 305, features corresponding to an area in which both of the tracking target and a similar object exist. Here, the area of the similar object is an area whose pixel values are larger than a threshold in the likelihood map 311 output from the tracking result calculation unit 205.

The second error calculation unit 208 calculates a second error in a feature space based on the respective features of the tracking target and the similar object obtained by the feature obtaining unit 207. The purpose of calculating the second error is to facilitate differentiation of the tracking target with use of the NN 309 by reducing the degree of similarity between the respective features of the tracking target and the similar object. The second error calculation unit 208 calculates, as the second error, a feature representation where the respective features of tracking targets are arranged closely to each other whereas the features of a similar object are arranged far from the features of a tracking target in the feature space. The method of calculating the second error will be described later.

The parameter updating unit 209 updates parameters of the feature extraction NN 302 and the NN 309 based on a loss, which is a weighted sum of both of the first error and the second error that are respectively calculated by the first error calculation unit 206 and the second error calculation unit 208.

The parameter storage unit 210 stores the parameters of the feature extraction NN 302 and the NN 309 updated by the parameter updating unit 209.

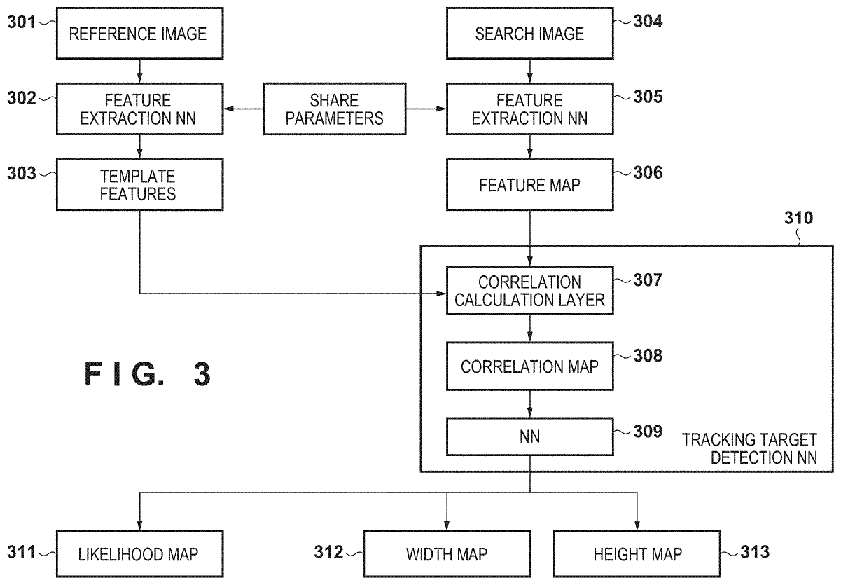

FIG. 3 is a diagram showing the configurations of neural networks. NN in the figure is an acronym for a neural network. The feature extraction NN 302 extracts first features from a reference image 301, and the feature extraction NN 305 extracts second features and third features from a search image 304. The feature extraction NN 302 and the feature extraction NN 305 both have a multi-layer structure for extracting features from an image, and share a part or all of parameters. The tracking target detection NN 310 is a neural network that estimates the position and the size of a tracking target, and includes the correlation calculation layer 307 and the NN 309. The feature extraction NN 302, the feature extraction NN 305, and the tracking target detection NN 310 include a convolutional layer (Convolution). While the foregoing NNs perform nonlinear transformation with a Rectified Linear Unit (hereinafter, ReLU) and the like, the type of nonlinear transformation is not limited to ReLU.

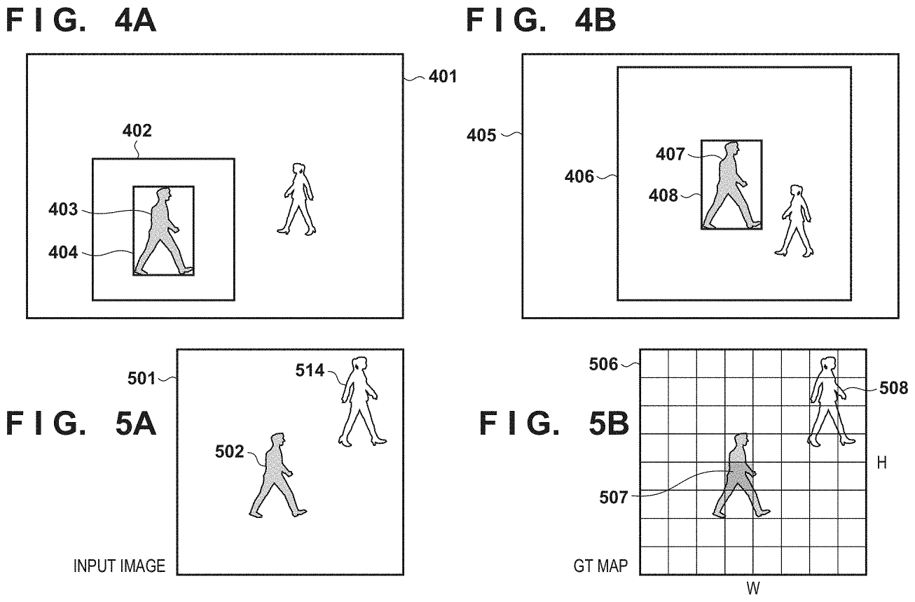

FIG. 4A shows one example of a reference image 401. The reference image 401 is an image obtained by the learning data obtaining unit 202. A template image 402 is an image obtained by cutting out the surrounding of the area of the tracking target 403. The learning data obtaining unit 202 obtains the template image 402 by cutting out an image of the surrounding of the area of the tracking target 403 within the reference image 401 as a template based on the position and the size of the tracking target 403, and resizing that image.

The learning data obtaining unit 202 can cut out the template image 402 from the reference image 401 by a factor of a constant number relative to the size of the tracking target 403, with the position of the tracking target 403 located at the center thereof. The tracking target 403 is an object that acts as a tracking target within the reference image 401, and includes, for example, a person; however, it may be an animal, a vehicle, or the like. Ground truth data 404 represents ground truth about the position and the size of the tracking target 403, and is indicated by a bounding box that encloses the tracking target 403.

FIG. 4B shows one example of the search image 405. The search image 405 is an image intended to search for a tracking target 407. A search range image 406 is an image obtained by cutting out, from the search image 405, an image that acts as a search range for the tracking target 407. The learning data obtaining unit 202 cuts out an image of the surrounding of the tracking target 407 within the search image 405 based on the position and the size of the tracking target 407, and resizes this image. The learning data obtaining unit 202, for example, cuts out the search range image 406 from the search image 405 by a factor of a constant number relative to the size of the tracking target 407, with the position of the tracking target 407 located at the center thereof.

The learning data obtaining unit 202 obtains a set of the search image 405 of the tracking target 407 and ground truth data 408 of the position and the size of the tracking target 407 that exists within this image. The learning data obtaining unit 202 obtains, for example, an image that is in the same sequence as the reference image 401 but is of a different time as the search image 405 of the tracking target 407. The tracking target 407 represents an object that acts as a tracking target and includes, for example, a person; however, it may be an animal, a vehicle, or the like. The ground truth data 408 represents ground truth about the position and the size of the tracking target 407, and is indicated by a bounding box that encloses the tracking target 407.

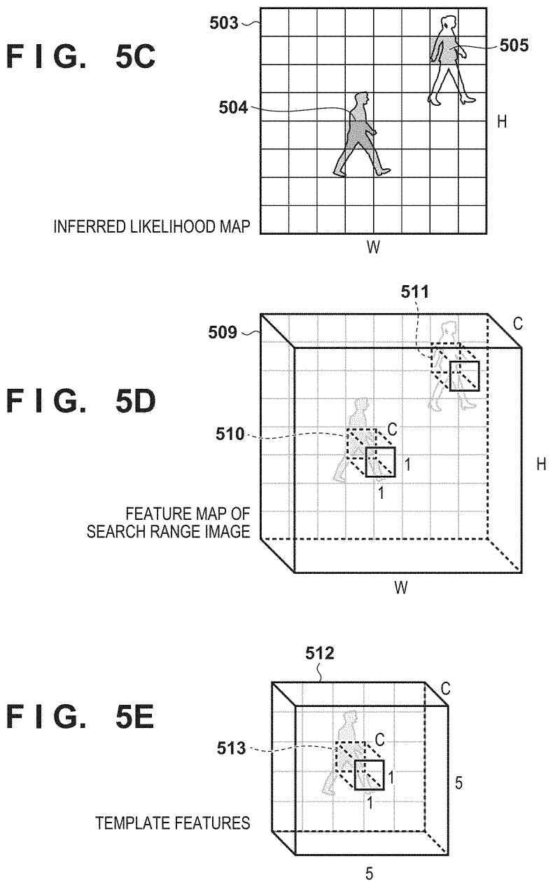

FIGS. 5A to 5E are diagrams showing examples of various types of images and the like that are supplied to the neural networks. FIG. 5A is a diagram showing an input image 501. The input image 501 includes a tracking target 502 and a similar object 514. The input image 501 is the same as the search range image 406. The tracking target 502 is an object that acts as a tracking target, and includes, for example, a person. The similar object 514 is not a tracking target but is an object similar to a tracking target, and includes, for example, a person.

FIG. 5B is a diagram showing a GT map 506. The GT map 506 includes a tracking target 507 and a similar object 508. The GT map 506 is an image indicating ground truth data of the positions of the tracking target 507 and the similar object 508. The GT maps of size maps (not shown) are two maps that have the same size as the GT map 506.

FIG. 5C is a diagram showing a likelihood map 503. The likelihood map 503 is an image which indicates the estimated results of the positions of a tracking target 504 and a similar object 505 that have been estimated by the tracking result calculation unit 205 from the search range image 406, and in which pixel values take values of real numbers from 0 to 1. The pixel values at positions where the tracking target 504 and the similar object 505 exist within the likelihood map 503, are displayed as relatively large values compared to other pixel values within the likelihood map 503.

Size maps (not shown) are two maps that have the same size as the likelihood map 503. Among the two maps, one map is a map that estimates the widths of the tracking target 504 and the similar object 505, and the other map is a map that estimates the heights of them. In the width estimation map (not shown), it is sufficient that the values of pixels corresponding to the central position of the tracking target 504 or the similar object 505 indicate the magnitude of the width of the tracking target 504 or the similar object 505. In the height estimation map (not shown), the pixel values corresponding to the central position of the tracking target 504 or the similar object 505 correspond to the height of the tracking target 504 or the similar object 505.

FIG. 5D is a diagram showing a feature map 509. The feature map 509 includes features 510 of the tracking target and features 511 of the similar object. The feature map 509 is an image that shows respective features of the tracking target and the similar object extracted from the search range image 406. The feature obtaining unit 207 cuts out, from the feature map 509, the features 510 of pixels that include the central position of the tracking target (the tracking target 507 of FIG. 5B). The feature obtaining unit 207 determines whether each pixel of the feature map 509 is an area in which the similar object exists. Specifically, the feature obtaining unit 207 determines that, in the likelihood map 503, a pixel with a likelihood higher than a threshold is the area in which the similar object exists. Then, the feature obtaining unit 207 cuts out the features 511 as the area in which the similar object exists from the feature map 509. Here, it is assumed that the feature obtaining unit 207 does not determine a pixel in the vicinity of the existence of the tracking target indicated by GT as the area of the similar object.

FIG. 5E is a diagram showing template features 512. The template features 512 include features 513 of a tracking target. The feature obtaining unit 207 obtains features 513 of 1×1×C by cutting out the feature of pixels at the center of the tracking target from the template image 402.

(Flow of Processing)

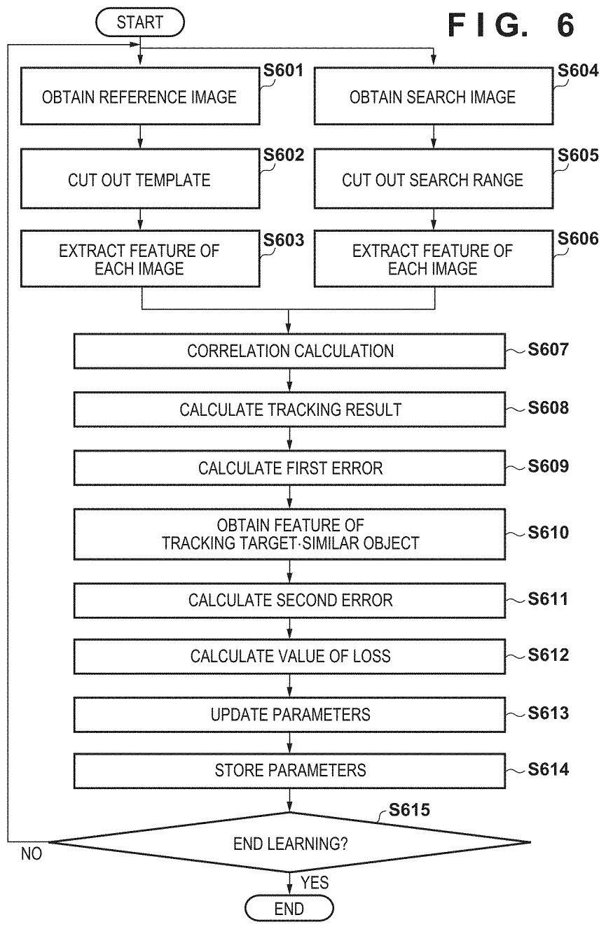

FIG. 6 is a flowchart of learning processing of the neural networks according to the first embodiment. The following describes the processing with reference to FIG. 1 and FIGS. 5A to 5E.

In step S601, the learning data obtaining unit 202 obtains the reference image 401 that shows the tracking target 403, as well as the ground truth data 404 of the central position and the size (width and height) of the tracking target 403 that exists within the reference image 401, from the storage unit 104.

In step S602, the learning data obtaining unit 202 obtains the template image 402 by cutting out an image of the surrounding of the area of the tracking target 403 within the reference image 401 based on the position and the size of the tracking target 403 as a template, and resizing that image.

In step S603, the feature extraction unit 203 obtains the template features 512 corresponding to the area of the tracking target 403 by inputting the template image 402 to the feature extraction NN 302. Although it is assumed here that the width, the height, and the number of channels of the template features 512 are 5×5×C (where C is an arbitrary positive constant), no limitation is intended by this.

In step S604, the learning data obtaining unit 202 obtains a pair of the search image 405 that shows the tracking target 407 and the ground truth data 408 of the position and the size of the tracking target 407 that exists within that image. The learning data obtaining unit 202 obtains, for example, an image that is in the same sequence as the reference image 401 obtained in step S602 but is of a different time as the search image 405 of the tracking target 407.

In step S605, the learning data obtaining unit 202 cuts out an image of the surrounding of the tracking target 407 within the search image 405 based on the position and the size of the tracking target 407, and resizes that image. The learning data obtaining unit 202 obtains the search range image 406 by, for example, cutting out the same from the search image 405 by a factor of a constant number relative to the size of the tracking target 407, with the position of the tracking target 407 located at the center thereof.

In step S606, the feature extraction unit 203 inputs the search range image 406 obtained in step S605 to the feature extraction NN 305, thereby obtaining the feature map 509 of the search range image 406. It is assumed here that the width, the height, and the number of channels of the feature map 509 are W×H×C. Note that although processing of steps S601 to S603 and processing of steps S604 to S606 in FIG. 6 are executed in parallel, one of them may be executed first.

In step S607, the parameter adaptation unit 204 sets the template features 512 as a parameter of the correlation calculation layer 307. In this way, the parameter adaptation unit 204 adapts the correlation calculation layer 307 inside the tracking target detection NN 310 for tracking of the tracking target 407. The tracking result calculation unit 205 causes the correlation calculation layer 307 to calculate cross-correlations between the feature map 509 and the template features 512.

In step S608, the tracking result calculation unit 205 inputs the calculation result obtained by the correlation calculation layer 307 to the NN 309 inside the tracking target detection NN 310, and outputs the likelihood map 503 and the size maps (not shown). The tracking result calculation unit 205 estimates the position and the size of the tracking target 407 in the search range image 406 based on the likelihood map 503 and the size maps (not shown).

In step S609, the first error calculation unit 206 calculates a first error based on the inferred results of the position and the size of the tracking target 407 (the likelihood map 503 and the size maps (not shown)) and the ground truth data 408. The purpose of calculating the first error is to cause the NN 309 to perform learning so that the tracking target 407 can be detected accurately from the search range image 406. The first error calculation unit 206 calculates a loss Loss_{c} relative to the ground truth data 408 of the inferred position of the tracking target 504, as well as a loss Lossₛ relative to the ground truth data 408 of the inferred size of the tracking target 504.

Loss_{c} is defined as in the following expression 1. The likelihood map 503 at the position of the tracking target 504 obtained in step S608 is denoted by C_{inf}, and a map that serves as the GT map 506 is denoted by C_{gt}. The first error calculation unit 206 calculates the sum of squared errors of each pixel between the map C_{inf} and the map C_{gt}. C_{gt} is a map in which the position where the tracking target 507 exists has a value of 1, and the position where it does not exist has a value of 0.

$$Loss c = \frac{1}{N} \sum {( {C}_{inf} - {C}_{ℊ t} )}^{2} \qquad ( Expression 1 )$$

Lossₛ is defined as in the following expression 2. The first error calculation unit 206 calculates the sum of squared errors of each pixel between output maps W_{inf}, H_{inf} of the width and height of the tracking target 504 and maps W_{gt}, H_{gt} that serve as the ground truth data (GT).

$${Loss}_{s} = \frac{1}{N} \sum {( {W}_{inf} - {W}_{ℊ t} )}^{2} + \frac{1}{N} \sum {( {H}_{inf} - {H}_{ℊ t} )}^{2} \qquad ( Expression 2 )$$

Here, with W_{gt} and H_{gt}, the values of the width and the height of the tracking target are respectively embedded in the position where the tracking target 507 exists. By calculating the loss with use of expression 2, the first error calculation unit 206 causes the NN 309 to perform learning so that, with respect to W_{inf} and H_{inf} as well, the width and the height of the tracking target are inferred at the position where the tracking target 507 exists. The following expression 3 is obtained by combining the two losses (Loss_{c}, Lossₛ).

Loss_{inf}=Loss_{c}+Lossₛ (Expression 3)

Although the losses have been described in the form of mean squared errors (hereinafter MSEs), no limitation is intended by this, and they may be, for example, Smooth-L1. Also, a loss function related to the position of the tracking target may be different from a loss function related to the size thereof.

In step S610, the feature obtaining unit 207 obtains a total of three types of features, including the first features from the reference image 401, and the second features and the third features from the search range image 406. The three types of features refer to the first features in the area of the tracking target 403 shown in the reference image 401, as well as the second features and the third features in the areas of the tracking target 407 and the similar object shown in the search range image 406, respectively. The feature obtaining unit 207 does not use the feature map 509 as is, but causes all of the three types of features to have the same width, height, and number of channels. This allows the feature obtaining unit 207 to calculate the later-described distances d₁ and d₂ with use of the three types of features in a feature space.

Although a description is now given of a case where the width, the height, and the number of channels of the three types of features are 1×1×C, no limitation is intended by this. Also, although the feature map 509 may be the output from an intermediate layer of the feature extraction NN 305, it is assumed to be the output from the same layer as the features used in the correlation calculation layer 307 in the following description.

First, with use of FIGS. 5A to 5E, a description is given of the method of obtaining the features in the area of the tracking target 407 shown in the search range image 406. The feature obtaining unit 207 cuts out, from the feature map 509, the features 510 that include the central position of the tracking target 407.

Next, with use of FIGS. 5A to 5E, a description is given of the method of obtaining the features in the area of the similar object shown in the search range image 406. The feature obtaining unit 207 determines whether each pixel of the feature map 509 is the area of the similar object. The feature obtaining unit 207 determines that, in the likelihood map 503, a pixel with a likelihood higher than a threshold is a feature of the similar object. Based on the determination criterion mentioned above, the feature obtaining unit 207 cuts out the features 511 as the area of the similar object from the feature map 509. Here, the feature obtaining unit 207 does not determine the pixels in the vicinity of the tracking target 507 shown in the GT map 506 as the area of the similar object. In order to obtain the first features of the tracking target 403 shown in the reference image 401, the feature obtaining unit 207 obtains the features 513 of 1×1×C by cutting out the features of the pixels that include the central position of the tracking target 403 from the template features 512. Note that the method of obtaining the first features of the tracking target 403 shown in the reference image 401 is not limited by this. After executing processing of step S606 with respect to the template image 402 and extracting the features from the feature extraction NN 302 that is the same as the search range image 406, the features 513 of 1×1×C may be obtained by cutting out the features of pixels that include the central position of the tracking target 403.

In step S611, the second error calculation unit 208 calculates a second error in a feature space in which the first features and the second features of the tracking target 407 and the third features of the similar object, which were obtained in step S610, exist. The inter-feature distance d between the first features of the tracking target 407 and the second features of the tracking target 407 or the third features of the similar object is calculated using, for example, the L1 norm shown in the following expression 4.

d=∥f₁−f₂∥₁ (Expression 4)

Here, f₁ denotes the first features of the tracking target, and f₂ denotes the second features of the tracking target or the third features of the similar object. The second error is obtained using, for example, a triplet loss function. Here, deep metric learning means a method of learning a feature amount space that takes the relationship between data pieces into consideration. In deep metric learning, the “distance” between two feature amounts reflects the “degree of similarity” between data pieces, and conversion is performed in such a manner that respective images are embedded in a space where input images with close meanings are at a close distance from each other, whereas input images with distant meanings are at a far distance from each other, for example. Loss functions in deep metric learning include not only a triplet loss, but also, for example, a contrastive loss, a classification error, and the like. The second error calculation unit 208 calculates a distance d₁ between the features 510 of the tracking target and the features 513 of the tracking target as indicated by expression 4. The calculation of d₁ uses the features 513 of the tracking target 403 within the reference image 401 (the first features) and the features 510 of the tracking target 407 within the search image 405 (the second features). Also, the second error calculation unit 208 calculates a distance d₂ between the features 513 of the tracking target (the first features) and the features 511 of the similar object (the third features) in accordance with expression 4. Here, the calculation of d₂ in the present embodiment uses the features 513 of the tracking target 403 within the reference image 401 (the first features) and the features 511 of the similar object within the search image 405 (the third features). Meanwhile, in another embodiment, the second error calculation unit 208 may calculate a distance d₂ between the features 510 of the tracking target (the second features) and the features 511 of the similar object (the third features). The second error calculation unit 208 calculates the relative magnitude of the inter-feature distance d₁ relative to the inter-feature distance d₂ as an error as indicated by expression 5.

Loss_{feat}=max(d₁−d₂+m,0) (Expression 5)

Here, m denotes a margin. According to expression 5, an object that is located at a distance larger than the margin from the tracking target in the feature space is 0. Therefore, the NN 309 can proceed with learning so that a confusing object located at a close distance from the tracking target is pushed away from the tracking target. Although the triplet loss function has been described here as an example of the second error, the calculation of the loss is not limited to using the same. Also, although the L1 norm has been described as an example of the inter-feature distance, a cosine distance or the like may be used, and the type of the inter-feature distance is not limited to these.

In step S612, the parameter updating unit 209 derives a loss Loss, which is a weighted sum of the first error Loss_{inf} and the second error Loss_{feat}, based on the following expression 6. It is assumed here that weighting coefficients λ₁ and λ₂ are equal to or larger than 0.

Loss=λ₁*Loss_{inf}+λ₂*Loss_{feat} (Expression 6)

In step S613, based on the calculated loss, the parameter updating unit 209 updates parameters of the feature extraction NN 302, the feature extraction NN 305, and the NN 309 with use of backpropagation. Here, the parameters refer to, for example, the weights of convolutional layers that compose the feature extraction NN 302, the feature extraction NN 305, and the tracking target detection NN 310. Note that in the present embodiment, the parameter updating unit 209 updates parameters of the feature extraction NN 302, the feature extraction NN 305, and the NN 309 based on the loss that includes the first error Loss_{inf} and the second error Loss_{feat}. Meanwhile, in another embodiment, the parameter updating unit 209 may update parameters of the feature extraction NN 302 and the feature extraction NN 305 based on the loss that includes the first error Loss_{inf} and the second error Loss_{feat}. It is assumed that, at this time, the parameter updating unit 209 does not update parameters of the NN 309.

In step S614, the parameter storage unit 210 stores the parameters of the feature extraction NN 302, the feature extraction NN 305, and the NN 309 that were updated by the parameter updating unit 209. Processing from step S601 to step S614 is defined as learning of one iteration.

In step S615, the parameter updating unit 209 determines whether to end learning of the NN 309 based on a predetermined ending condition. The condition for determining that learning is to be ended may be one of a case where the value of the loss obtained using expression 6 is smaller than a predetermined threshold, and a case where the NN 309 has executed learning for a prescribed number of times. In a case where the parameter updating unit 209 has determined that learning of the NN 309 is to be ended in step S615 (Yes of step S615), processing is ended. In a case where the parameter updating unit 209 has determined that learning of the NN 309 is not to be ended in step S615 (No of step S615), processing returns to step S601.

The parameter updating unit 209 updates parameters of the feature extraction NN 302, the feature extraction NN 305, and the NN 309 so that, with regard to the features used in correlation calculation, the features of tracking targets are embedded closely to each other whereas the features of a similar object are embedded far from the features of a tracking target in a feature space. In this way, the features of a tracking target and the features of a similar object are differentiated, and the tracking target becomes easily detected after the correlation calculation. Also, the parameter updating unit 209 can facilitate learning for differentiating a tracking target and a similar object by actively using a similar object that has a high likelihood in the likelihood map 503 in metric learning of the features used in correlation calculation.

Furthermore, in a case where the weighting coefficients λ₁ and λ₂ of the loss in expression 6 of step S612 are both positive, the parameter updating unit 209 can use the first error and the second error simultaneously in updating of parameters. In this case, the parameter updating unit 209 performs, simultaneously with metric learning associated with the respective features of a tracking target and a similar object that are used in correlation calculation, end-to-end optimization of parameters between feature extraction and detection of a tracking target. In this way, the present embodiment can provide the NN 309, which plays a role in detection of a tracking target, with a detection performance for detecting candidates for a tracking target from a background area within a search image, as well as a differentiation performance for differentiating a tracking target and a similar object. In addition, the feature extraction NN 302 and the feature extraction NN 305 can extract features which allow the NN 309 to easily detect a tracking target from a background, and with which a tracking target and a similar object are easily differentiated.

As described above, according to the first embodiment, in order to improve the accuracy of detection of a tracking target, a first error between the estimated result of the position of the tracking target, which has been estimated by a tracking target detection NN from a search image, and ground truth data thereof. Also, according to the first embodiment, a second error, which is a relative magnitude of the distance between features of tracking targets in a feature space relative to the distance between respective features of a tracking target and a similar object, is calculated. Furthermore, in the first embodiment, parameters of the feature extraction NN 302 and the feature extraction NN 305 are updated based on the first error and the second error. Accordingly, in the first embodiment, the degree of similarity between features of a tracking target and a similar object can be lowered, and the accuracy of detection of a tracking target within a search image can be improved.

### Second Embodiment

In a second embodiment, the feature obtaining unit 207 causes a threshold for likelihoods to fluctuate in accordance with the number of areas of a similar object in the likelihood map 503 in step S610 of FIG. 6. For example, the feature obtaining unit 207 causes the threshold for likelihoods in the likelihood map 503 to fluctuate in a case where it obtains k or more areas of a similar object in the likelihood map 503. Assume that there are m areas of a similar object with a likelihood equal to or higher than the threshold in the likelihood map 503 that was output by the tracking result calculation unit 205 in step S608. In a case where the number of areas of the similar object is k>m, the number of areas of the similar object that is obtained by the feature obtaining unit 207 in the next iteration is smaller than k. In view of this, the feature obtaining unit 207 multiplies the threshold for likelihoods in the likelihood map 503 to be used in the next iteration by a (where 0≤a<1). In this way, the feature obtaining unit 207 can increase the number of areas of the similar object in the likelihood map 503. Alternatively, the feature obtaining unit 207 may re-obtain the areas of the similar object by reducing the threshold for likelihoods in the likelihood map 503 so that k or more areas of the similar object can be obtained in the same iteration. Note that the method of increasing the areas of a similar object in the likelihood map 503 is not limited to this.

In a case where the feature obtaining unit 207 determines pixels with a likelihood equal to or higher than the threshold in the likelihood map 503 as the areas of a similar object, the number of the areas of the similar object in the likelihood map 503 decreases as learning of the NN 309 progresses. Then, the number of examples that are used when the second error calculation unit 208 calculates a second error decreases, thereby hindering the progress of metric learning of intermediate features in the NN 309. In view of this, the feature obtaining unit 207 causes the threshold for likelihoods in the likelihood map 503 to be used in determination of the areas of a similar object to fluctuate in accordance with the status of the progress of learning of the NN 309.

As described above, according to the second embodiment, a reduction in the number of areas of a similar object is prevented in the stage where learning of the NN 309 has progressed. As a result, the second embodiment can cause the NN 309 to perform metric learning that uses the first features or the second features of a tracking target and the third features of a similar object while maintaining balance between the number of negative examples and the number of positive examples.

### Third Embodiment

According to a third embodiment, in step S604 of FIG. 6, the learning data obtaining unit 202 obtains an image that shows a similar object of the same category as a tracking target from, for example, a database such as the storage unit 104. The second error calculation unit 208 calculates a second error using this image. First, a description is given of the obtainment of an image that shows a similar object by the learning data obtaining unit 202. Each image that is prepared in the database in advance includes ground truth data (GT) of the position and the size (height, width) of an object that is shown within the image, as well as information of the category of the object (e.g., a person, an animal, or a vehicle). In step S604, the learning data obtaining unit 202 obtains one or more pairs of an image of a similar object of the same category as a tracking target, and GT of the position and the size of the similar object that exists within this image. Here, the learning data obtaining unit 202 obtains a search range image of the tracking target and GT of a search image, which are obtained in step S604, similarly to the first embodiment.

Next, in step S610, the feature obtaining unit 207 obtains features of the similar object from the image that shows the similar object. The feature obtaining unit 207 obtains the third features of the similar object from the image that shows the similar object in a procedure similar to the obtainment of the second features of the tracking target from the search range image, as has been described in relation to step S610 of FIG. 6. Then, in step S611, when calculating a second error, the second error calculation unit 208 uses the third features of the similar object obtained in the foregoing manner. In step S611, the second error calculation unit 208 may calculate the second error with use of the third features of the similar object shown in the search range image together with the third features of the similar object obtained from the image that shows the similar object.

As described above, according to the third embodiment, the third features of a similar object are obtained from another image that is different from a search image from which the second features of a tracking target are obtained; this increases variations of negative examples used in metric learning of intermediate features. As a result, the generalization performance of a neural network (NN) that identifies a tracking target from a new search image is improved.

### Fourth Embodiment

According to the fourth embodiment, in step S612 of FIG. 6, the parameter updating unit 209 causes the weighting coefficients λ₁ and λ₂ for the loss to fluctuate adaptively. The parameter updating unit 209 updates the weighting coefficients λ₁ and λ₂, together with parameters of the neural networks (NNs), using a gradient method. First, the loss Loss is defined as in the following expression 7.

$$Loss = {λ}_{1}^{2} * {Loss}_{Inf} + {λ}_{2}^{2} * {Loss}_{feat} + log ( \frac{1}{{λ}_{1}} ) + log ( \frac{1}{{λ}_{2}} ) \qquad ( Expression 7 )$$

According to expression 7, the squares of the weighting coefficients λ₁ and λ₂ are used in the first term and the second term, respectively; this prevents the weighting coefficient from becoming negative. Also, the third term and the fourth term prevent the weighting coefficients λ₁ and λ₂ from becoming 0 when the feature extraction NN 302, the feature extraction NN 305, and the NN 309 perform learning. In this way, minimization of the loss in the next step is appropriately performed. The definition of the loss is not limited the one described above. Next, in step S613, the parameter updating unit 209 causes the feature extraction NN 302, the feature extraction NN 305, and the NN 309 to learn the weighting coefficients λ₁ and λ₂ as well with use of a gradient method and the like based on the loss defined by expression 7. In this way, the parameter updating unit 209 causes the weighting coefficients λ₁ and λ₂, which are respectively for the first error Loss_{Inf} and the second error Loss_{feat}, to fluctuate in accordance with the status of learning of the feature extraction NN 302, the feature extraction NN 305, and the NN 309. Here, the parameter updating unit 209 may fix one of the weighting coefficients λ₁ and λ₂, and cause an unfixed one of the weighting coefficients λ₁ and λ₂ to fluctuate.

In order to detect a tracking target, it is necessary to differentiate not only the tracking target and a similar object, but also differentiate a background other than the similar object, which is a non-tracking target, and a tracking target, in a search range image. The second error promotes improvements in the differentiation performance associated with differentiation between a tracking target and a similar object by the NNs. However, in a case where the weighting coefficient for the second error is excessively large relative to that for the first error, there is a possibility that differentiation between a background and a tracking target by the NNs are adversely affected. In view of this, the fourth embodiment causes the NNs to learn the first error and the second error in a balanced manner, and thus the performance of detection of a tracking target and the performance of differentiation between a tracking target and a similar object can be achieved at the same time.

(Exemplary Modification)

The parameter updating unit 209 switches between updating of parameters based on the first error and updating of parameters based on the second error in the midst of learning in accordance with the magnitude of the loss. First, the parameter updating unit 209 causes the feature extraction NN 302, the feature extraction NN 305, and the NN 309 to perform learning based only on the first error. Thereafter, the parameter updating unit 209 causes the feature extraction NN 302, the feature extraction NN 305, and the NN 309 to switch to learning based only on the second error at a timing when the loss no longer decreases. In order to cause the feature extraction NN 302, the feature extraction NN 305, and the NN 309 to perform learning based only on the first error, the parameter updating unit 209 sets 0 as the weighting coefficient λ₂ in the loss in step S612 of FIG. 6. Also, in order to cause the feature extraction NN 302, the feature extraction NN 305, and the NN 309 to perform learning based only on the second error, the parameter updating unit 209 sets 0 as the weighting coefficient λ₁ in the loss in step S612 of FIG. 6. In addition, in learning of the feature extraction NN 302, the feature extraction NN 305, and the NN 309 based on the second error, the parameter updating unit 209 may cause these NNs to perform learning based on the first error at a timing when the loss no longer decreases.

### Fifth Embodiment

A fifth embodiment will be described using an example in which the above-described metric learning is applied to learning of the NNs based on an online tracking method. Here, online tracking refers to a tracking method in which, during inference of the NNs, an object detection NN that has already performed learning is fine-tuned with use of a reference image that shows a tracking target and a similar object. Fine tuning refers to a method of finely adjusting the weights of a part or all of layers of a learned model. According to the fifth embodiment, a tracking target can be detected from a new image by updating the object detection NN with use of a gradient method and importing information of the tracking target. There are two differences between the online tracking method and the Siam method.

The online tracking method is different from the Siam method in terms of the way of use of features extracted from a reference image. While the Siam method uses only the first features of the area of a tracking target extracted from a reference image as the template features 512, the online tracking method also uses the third features of the area of a similar object in addition to the first features of a tracking target within a reference image. Furthermore, in adapting parameters of the NNs to a tracking task for a tracking target, the online tracking method fine-tunes the weights of layers of the NNs with use of a gradient method without calculating correlations between the template features 512 and the features of a search image.

In order to achieve the tracking performance of the NNs by way of fine tuning during inference, the online tracking method sets appropriate weights of layers as parameters of the NNs by causing the NNs to perform prior learning. The online tracking method performs metric learning that uses both of the first features of a tracking target and the third features of a similar object as intermediate features with use of the NNs at the time of prior learning, thereby facilitating the NNs' differentiation between the tracking target and the similar object during inference.

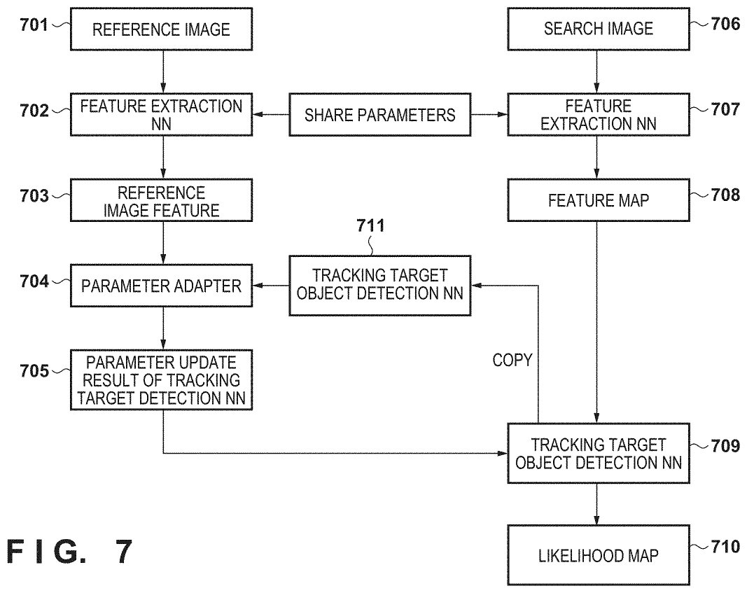

The fifth embodiment includes the configuration of the information processing apparatus 10 and the functional configuration of the information processing apparatus at the time of learning that are similar to those of the first embodiment; therefore, a description thereof is omitted. FIG. 7 is a diagram showing examples of configurations of neural networks used with the online tracking method.

A feature extraction NN 702 and a feature extraction NN 707 correspond to the feature extraction unit 203 of FIG. 2. A parameter adapter 704 corresponds to the parameter adaptation unit 204 of FIG. 2. A tracking target detection NN 709 corresponds to the tracking result calculation unit 205. Although each NN includes a layer that performs nonlinear transformation similarly to a convolutional layer, an ReLU layer, and the like, the type of the layer that performs nonlinear transformation is not limited to these. Also, the tracking target detection NN 709 may not only estimate a likelihood map 710 shown in FIG. 7, but also estimate the width and the height of a tracking target. At this time, the parameter adaptation unit 204 may use parameters of the NNs for estimating the width and the height of a tracking target as parameters to be adapted to the NNs.

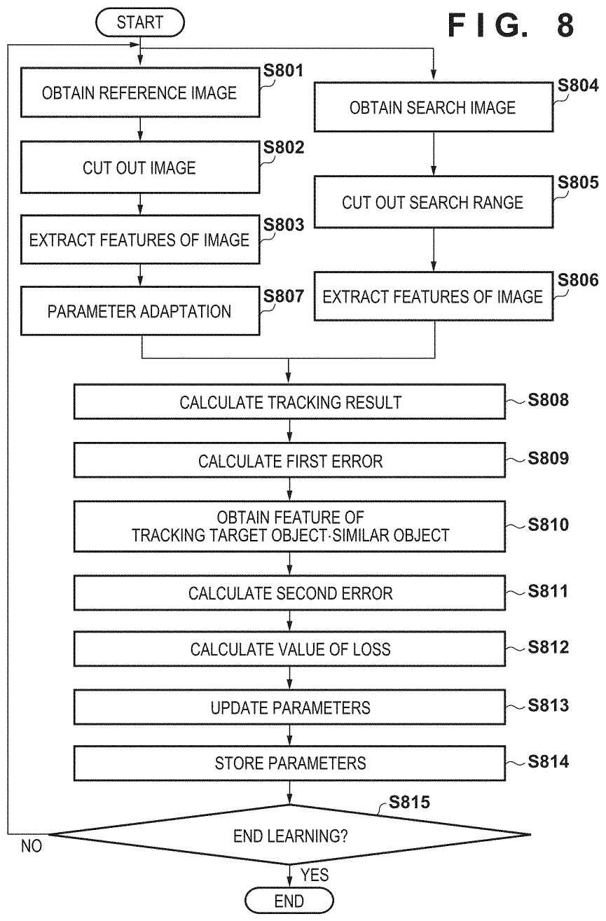

FIG. 8 is a flowchart showing a flow of prior learning of NNs according to the fifth embodiment.

In step S801, the learning data obtaining unit 202 obtains, from the storage unit 104, a pair of a reference image 401 and ground truth data 404 of the positions and the sizes of a tracking target 403 and a similar object shown in the reference image 401. Although the learning data obtaining unit 202 obtains one reference image 401 here, it may obtain a plurality of images that have been captured in the same time sequence as the reference image 401 but at a different time. In this case, the learning data obtaining unit 202 obtains ground truth data 404 of the position and the size from each image with respect to the same tracking target 403. Also, the learning data obtaining unit 202 may obtain a plurality of pairs of the reference image 401 and the ground truth data 404 with respect to the same tracking target 403 by way of data augmentation (data expansion).

In step S802, the learning data obtaining unit 202 obtains the template image 402 by cutting out an image of the surrounding including the tracking target 403 and the similar object from the reference image 401.

In step S803, the feature extraction unit 203 obtains the template features 512 by inputting the template image 402 to the feature extraction NN 702. It is assumed here that the width, the height, and the number of channels of the template features 512 are 5×5×C.

In step S804, the learning data obtaining unit 202 obtains the search image 405 and the ground truth data 408 of the position and the size of the tracking target 407 shown in the search image 405.

In step S805, the learning data obtaining unit 202 obtains the search range image 406 by cutting out an image of the surrounding of the tracking target 407 from the search image 405.

In step S806, the feature extraction unit 203 obtains the feature map 509 by inputting the search range image 406 to the feature extraction NN 702. It is assumed here that the width, the height, and the number of channels of the feature map 509 are W×H×C. Although the learning data obtaining unit 202 obtains one search image 405, it may obtain a plurality of images that have been captured in the same time sequence but at a different time. In this case, the learning data obtaining unit 202 obtains ground truth data 408 of the position and the size from each image with respect to the same tracking target 407.

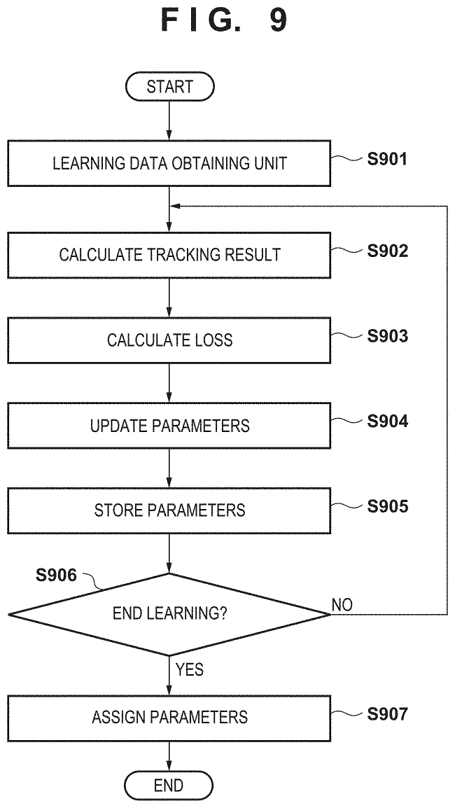

In step S807, the parameter adaptation unit 204 generates a tracking target detection NN 711 by making a copy of the tracking target detection NN 709. The parameter adaptation unit 204 updates parameters of the tracking target detection NN 711 through processing shown in FIG. 9, and assigns the weights of the updated parameters to parameters of the tracking target detection NN 709. Here, FIG. 9 shows a flowchart of parameter updating processing in the online tracking method.

In step S901, the parameter adapter 704 obtains a plurality of pairs of a feature amount and a label, which are learning data, from the learning data storage unit 201.

In step S902, the parameter adapter 704 obtains the likelihood map 710 by inputting the feature amounts to the tracking target detection NN 711. Here, the likelihood map 710 is the same as the likelihood map calculated in step S608 of FIG. 6 (the likelihood map 503 of FIG. 5C). Pixel values of the likelihood map 710 take values of real numbers from 0 to 1.

In step S903, the parameter adapter 704 calculates a loss of the position of the tracking target 407 with use of the likelihood map 710 and the GT map 506 that indicates ground truth about the position of the tracking target 407. Although the parameter adapter 704 calculates the loss with use of expression 8, the calculation formula of the loss is not limited to this. Assuming that the likelihood map 710 is C_{inf} and the GT map 506 that indicates ground truth about the position of the tracking target 407 is C_{gt}, the parameter adapter 704 calculates the sum of squared errors of each pixel between C_{inf} and C_{gt}. Here, C_{gt}(the GT map 506) indicates that the pixel values at positions where the tracking target 407 exists are 1, and the pixel values at positions where the tracking target 407 does not exist are 0.

$${Loss}_{finetune} = \frac{1}{N} \sum {( {C}_{inf} - {C}_{ℊ t} )}^{2} \qquad ( Expression 8 )$$

In step S904, the parameter adapter 704 updates parameters of the tracking target detection NN 711 based on the loss with use of a gradient method, such as stochastic gradient descent (SGD) and Newton's method.

In step S905, the parameter adapter 704 stores the parameters of the tracking target detection NN 711 into the parameter storage unit 210.

In step S906, the parameter updating unit 209 determines whether to end learning of the tracking target detection NN 711. The condition for determining that learning is to be ended may be a case where the value of the loss obtained using expression 8 is smaller than a predetermined threshold, or a case where learning of the tracking target detection NN 711 has been completed a prescribed number of times.

In a case where the parameter updating unit 209 has determined that learning of the tracking target detection NN 711 is to be ended in step S906 (Yes of step S906), processing proceeds to step S907. In a case where the parameter updating unit 209 has determined that learning of the tracking target detection NN 711 is not to be ended in step S906 (No of step S906), processing proceeds to step S902.

In step S907, the parameter updating unit 209 ends learning processing for the tracking target detection NN 711.

Returning to the description of FIG. 8, when processing of step S907 ends, processing of step S807 ends. The parameter updating unit 209 deems parameters obtained after updating parameters of the tracking target detection NN 711 k times as θₖ, and performs fine tuning by updating the tracking target detection NN 711 with these parameters. In step S907, the parameter updating unit 209 assigns the values of the parameters θₖ of the tracking target detection NN 711 to parameters of the tracking target detection NN 709, and uses the result of the assignment in processing of step S808 onward. At this time, the original parameters θ₀ of the tracking target detection NN 709 are stored into the storage unit 104.

In step S808, the tracking result calculation unit 205 outputs the likelihood map 710 by inputting the feature map 509 of the search image 405 to the tracking target detection NN 709. The likelihood map 710 is the same as the likelihood map calculated in step S608 of FIG. 6 (the likelihood map 503 of FIG. 5C). Pixel values of the likelihood map 710 take values of real numbers from 0 to 1. In a case where the pixel values of the positions where the tracking target 407 (e.g., a person) exists in the likelihood map 710 are relatively large compared to the values of other pixels within this map, the tracking target detection NN 709 can track the tracking target 407 accurately.

In step S809, the first error calculation unit 206 obtains a first error Loss_{inf} by calculating a loss Loss_{c} of the result of inferring the position of the tracking target 407 relative to the ground truth data 408.

Processing of steps S810 to S815 is processing that is similar to steps S610 to S615 of FIG. 6, and thus a description thereof is omitted. Note that in step S813, with regard to the original parameters θ₀ of the tracking target detection NN 709 before updating parameters in step S907, the parameter updating unit 209 derives θ₀ that minimizes the loss.

(Inference of Online Tracking)

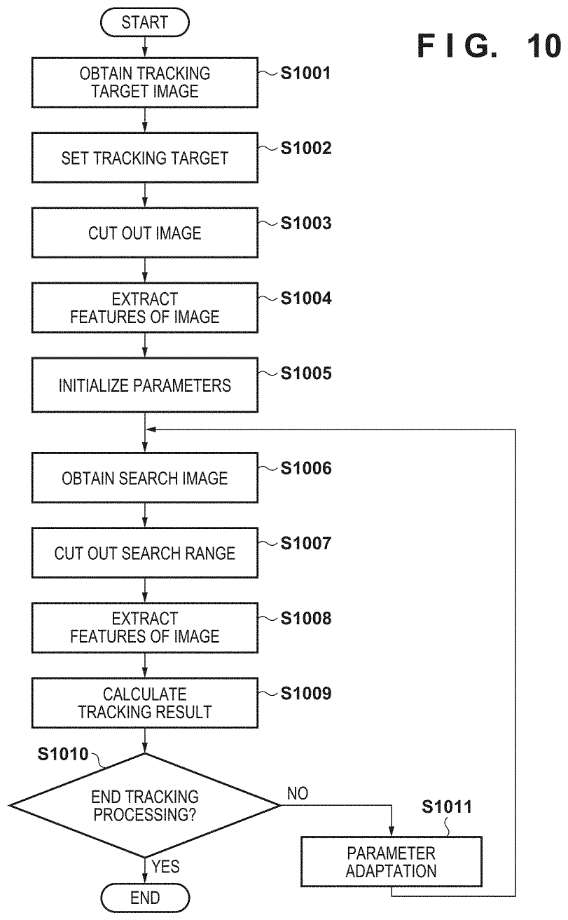

With use of FIGS. 9 and 10, the following describes a flow of inference processing for detecting a tracking target from chronological images through online tracking of the NNs. It is assumed here that the NNs used in online tracking have performed prior learning in which parameters adapted for tracking of the tracking target 407 are updated, as stated earlier. FIG. 10 is a flowchart of inference processing in an online tracking method.

In step S1001, the learning data obtaining unit 202 obtains a search image 405 that shows a tracking target 407 from the learning data storage unit 201.

In step S1002, the input unit 105 designates a surrounding area of a tracking target within the search image 405, and sets this area as the tracking target 407. Examples of the method of setting the tracking target 407 include a method in which a user touches and thus designates a tracking target from the search image 405 displayed on the display unit 106, a method in which a tracking target is designated by detecting an object with use of an object detector (not shown), and the like. Then, the input unit 105 sets the position and the size of a bounding box that encloses the area of the tracking target 407 within the search image 405 as GT of the tracking target 407.

In step S1003, the learning data obtaining unit 202 obtains the search range image 406 by cutting out the image of the surrounding of the tracking target 407 from the search image 405.

In step S1004, the feature extraction unit 203 obtains the feature map 509 by inputting the search range image 406 to the feature extraction NN 702. It is assumed here that the width, the height, and the number of channels of the feature map 509 are W×H×C.

In step S1005, the parameter adaptation unit 204 generates the tracking target detection NN 711 by making a copy of the tracking target detection NN 709. The parameter adaptation unit 204 updates parameters of the tracking target detection NN 711 by executing processing shown in FIG. 9, and assigns the weights of the updated parameters to parameters of the tracking target detection NN 709.

In step S1006, the learning data obtaining unit 202 obtains an image of the tracking target 407 captured by an image capturing unit (not shown). From then on, the tracking target detection NN 709 searches for the tracking target 407 set in step S1002 from the obtained image.

In step S1007, the learning data obtaining unit 202 obtains the search range image 406 by cutting out, from the image, an image that serves as a search range for the tracking target 407. The search range for the tracking target 407 within the image may be determined based on the surrounding area of the position of the tracking target 407 that was detected from an immediately-preceding image for which tracking was performed.

In step S1008, the feature extraction unit 203 obtains the feature map 509 by inputting the search range image 406 to the feature extraction NN 702. It is assumed here that the width, the height, and the number of channels of the feature map 509 are W×H×C. The feature extraction unit 203 stores the feature map 509 into the storage unit 104.

In step S1009, the tracking result calculation unit 205 outputs the likelihood map 710 by inputting the feature map 509 of the search range image 406 to the tracking target detection NN 709 that has parameters updated in step S1005. The likelihood map 710 is the same as the map shown as the likelihood map 503 in FIG. 5C, and pixel values of the likelihood map 710 take values of real numbers from 0 to 1. In a case where the pixel values of the positions where the tracking target 407 (e.g., a person) exists are relatively large compared to the values of pixels at the positions where the tracking target 407 does not exist in the likelihood map 710, the tracking target detection NN 709 can track the tracking target 407 accurately. The size of the tracking target 407 may be the size of the tracking target 407 obtained in step S1002, or may be the size estimated by the tracking target detection NN 709. Also, the tracking result calculation unit 205 stores the tracking result into the storage unit 104.

In step S1010, the tracking result calculation unit 205 determines whether to end tracking of the tracking target 407. The condition for ending tracking processing may be a condition that has been designated by the user in advance. In a case where the tracking result calculation unit 205 has determined that tracking processing is not to be ended (No of step S1010), processing returns to step S1011, and tracking of the tracking target 407 is continued. In a case where the tracking result calculation unit 205 has determined that tracking processing is to be ended (Yes of step S1010), tracking processing for the tracking target 407 is ended.

In step S1011, the tracking result calculation unit 205 updates parameters of the tracking target detection NN 709 based on the result of tracking the tracking target 407. Parameter adaptation is similar to parameter adaptation that was executed in step S802 during prior learning of the tracking target detection NN 709 (shown in FIG. 9), processing of step S1011 is different from processing of step S901. In step S1011, the tracking result calculation unit 205 may generate GT about the position of the tracking target 407 based on the tracking result from a previous search range image 406, instead of using pre-provided ground truth data (GT) of the position of the tracking target 407. For example, the tracking result calculation unit 205 may obtain, as GT, the position and the size of the tracking target 407 indicated by the tracking result obtained in step S1009. In this way, the tracking result calculation unit 205 can reflect, in parameters, information of the appearance of the tracking target 407 that changes moment by moment and a similar object that has newly appeared.

As described above, according to the fifth embodiment, metric learning is performed while using the first features of a tracking target and the third features of a similar object as intermediate features during prior learning of the NNs, and parameters of the NNs are fine-tined with respect to a tracking task for a tracking target. As a result, in the fifth embodiment, the tracking target that changes in position and the like from moment to moment can easily be differentiated from a similar object that newly appears in a search image.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-165650, filed Oct. 7, 2021, which is hereby incorporated by reference herein in its entirety.

What is claimed is:

1. An information processing apparatus comprising:
an obtaining unit configured to obtain a reference image and a search image that show a tracking target, and ground truth data indicating a position of the tracking target within the search image;
an extraction unit configured to extract features of respective positions in an image;
an estimation unit configured to, based on the features of the respective positions in the image extracted by the extraction unit, estimate a position where the tracking target exists within an image;
a first error calculation unit configured to calculate a first error between a position of the tracking target within the search image that has been estimated by the estimation unit and the position of the tracking target within the search image that is indicated by the ground truth data;
a feature obtaining unit configured to obtain first features, second features, and third features, the first features being features of the tracking target that have been extracted by the extraction unit from the reference image, the second features being features of the tracking target at the position indicated by the ground truth data that have been extracted by the extraction unit from the search image, the third features being features of a similar object similar to the tracking target that have been extracted by the extraction unit at least from the search image;
a second error calculation unit configured to calculate, as a second error, a relative magnitude of a distance between the first features and the second features relative to a distance between the first features or the second features and the third features in a feature space; and
an updating unit configured to update a parameter used by the extraction unit in extraction of the features based on the first error and the second error.

2. The information processing apparatus according to claim 1, wherein
the estimation unit estimates a likelihood of existence of the tracking target with respect to each position within the search image.

3. The information processing apparatus according to claim 1, wherein
the feature obtaining unit obtains, as the third features of the similar object similar to the tracking target, features which have been extracted from the search image, which have a likelihood of existence of the tracking target higher than a threshold, and which are at positions that are not equivalent to the position of the tracking target within the search image indicated by the ground truth data.

4. The information processing apparatus according to claim 3, wherein
the feature obtaining unit causes the threshold for a likelihood while the updating unit repeatedly updates the parameter.

5. The information processing apparatus according to claim 1, wherein
the feature obtaining unit obtains the third features extracted by the extraction unit from a pre-prepared image that shows the similar object.

6. The information processing apparatus according to claim 1, wherein
the extraction unit extracts the features of the respective positions in the image with use of a neural network, and
the estimation unit estimates the position where the tracking target exists within the search image with use of a neural network.

7. The information processing apparatus according to claim 1, wherein
the updating unit updates a parameter used by the estimation unit in estimation of the position where the tracking target exists within the search image based on the first error and the second error.

8. The information processing apparatus according to claim 1, wherein
the second error calculation unit calculates the second error with use of a triplet loss.

9. The information processing apparatus according to claim 1, wherein
the similar object belongs to the same object category as the tracking target.

10. The information processing apparatus according to claim 1, wherein
the updating unit updates the parameter in accordance with a loss that has been calculated based on both of the first error and the second error.

11. The information processing apparatus according to claim 1, wherein
the updating unit updates the parameter in accordance with a loss that has been calculated by weighting and combining the first error and the second error while changing respective weights for the first error and the second error.

12. The information processing apparatus according to claim 1, wherein
the estimation unit estimates the position where the tracking target exists within the search image based on the first features that are the features of the tracking target extracted by the extraction unit from the reference image, and on features of respective positions in the search image extracted by the extraction unit.

13. The information processing apparatus according to claim 12, wherein
the estimation unit estimates the position where the tracking target exists within the search image based on cross-correlations between the first features that are the features of the tracking target extracted by the extraction unit from the reference image and features of respective positions in the search image extracted by the extraction unit.

14. The information processing apparatus according to claim 1, wherein
the estimation unit estimates the position where the tracking target exists within the search image with use of a parameter that has been updated based on an error between a position of the tracking target within the reference image estimated by the estimation unit based on the features of the tracking target extracted by the extraction unit from the reference image and a position of the tracking target within the reference image indicated by ground truth data corresponding to the reference image.

15. The information processing apparatus according to claim 1, further comprising
an acceptance unit configured to accept a designation of the tracking target within the search image.

16. The information processing apparatus according to claim 1, wherein
the estimation unit further estimates a size of the tracking target within the search image based on features of respective positions in the search image extracted by the extraction unit.

17. An information processing apparatus comprising:
an obtaining unit configured to obtain a search image and ground truth data indicating a position of a tracking target within the search image;
an extraction unit configured to extract features of respective positions in an image;
an estimation unit configured to, based on features of respective positions in the search image extracted by the extraction unit, estimated a likelihood of existence of the tracking target with respect to each position within the search image;
a feature obtaining unit configured to obtain first features and third features, the first features being features of the tracking target that have been extracted by the extraction unit from the search image, the third features being features of a similar object similar to the tracking target which have been extracted by the extraction unit from the search image and which are at a position of the similar object estimated based on the likelihood and on the ground truth data indicating the position of the tracking target within the search image; and
an updating unit configured to update a parameter used by the extraction unit in extraction of the features based on a distance between the first features and the third features in a feature space.

18. A method comprising:
obtaining a reference image and a search image that show a tracking target, and ground truth data indicating a position of the tracking target within the search image;
extracting features of respective positions in an image;
estimating, based on the features of the respective positions in the image extracted, a position where the tracking target exists within an image;
calculating a first error between a position of the tracking target within the search image that has been estimated and the position of the tracking target within the search image that is indicated by the ground truth data;
obtaining first features, second features, and third features, the first features being features of the tracking target that have been extracted from the reference image, the second features being features of the tracking target at the position indicated by the ground truth data that have been extracted from the search image, the third features being features of a similar object similar to the tracking target that have been extracted at least from the search image;
calculating, as a second error, a relative magnitude of a distance between the first features and the second features relative to a distance between the first features or the second features and the third features in a feature space; and
updating a parameter used in extraction of the features based on the first error and the second error.

19. A non-transitory computer-readable storage medium storing a program that, when executed by a computer, causes the computer to perform a method comprising:
obtaining a reference image and a search image that show a tracking target, and ground truth data indicating a position of the tracking target within the search image;
extracting features of respective positions in an image,
estimating, based on the features of the respective positions in the image extracted, a position where the tracking target exists within an image;
calculating a first error between a position of the tracking target within the search image that has been estimated and the position of the tracking target within the search image that is indicated by the ground truth data;
obtaining first features, second features, and third features, the first features being features of the tracking target that have been extracted from the reference image, the second features being features of the tracking target at the position indicated by the ground truth data that have been extracted from the search image, the third features being features of a similar object similar to the tracking target that have been extracted at least from the search image;
calculating, as a second error, a relative magnitude of a distance between the first features and the second features relative to a distance between the first features or the second features and the third features in a feature space; and
updating a parameter used in extraction of the features based on the first error and the second error.
